(19) United States
(12) Patent Application Publication
(10) Pub. No.: US 2012/0121024 A1
(43) Pub. Date: May 17, 2012

(54) METHOD AND APPARATUS FOR PARALLEL ENTROPY ENCODING AND PARALLEL ENTROPY DECODING BASED ON DECODING RATE

(75) Inventor: Yun-gu LEE, Seongnam-si (KR)

(73) Assignee: SAMSUNG ELECTRONICS CO., LTD., Suwon-si (KR)

(21) Appl. No.: 13/356,376

(22) Filed: Jan. 23, 2012

Related U.S. Application Data
(63) Continuation-in-part of application No. 12/916,767, filed on Nov. 1, 2010.

(30) Foreign Application Priority Data
Oct. 30, 2009 (KR) 10-2009-0104426

(51) Int. Cl. H04N 7/26

(52) U.S. Cl. 375/240.26; 375/E07.2

(57) ABSTRACT

Provided are an entropy encoding method, an entropy decoding method, an entropy encoding apparatus, and an entropy decoding apparatus. The entropy encoding method includes: generating bitstreams by dividing video data into a plurality of data groups, encoding each of the data groups so as to generate symbols, and performing entropy encoding on the symbols; classifying the generated bitstreams into a plurality of classes such that bitstreams of neighboring data groups are classified into different classes; determining, from among a plurality of segments divided from a datastream, segments to which one or more bitstreams of a same class are allocated based on decoding rates of the bitstreams; and outputting a datastream including bitstreams allocated to each segment.

### CROSS-REFERENCE TO RELATED PATENT APPLICATION

This application is a continuation-in-part of U.S. patent application Ser. No. 12/916,767, filed Nov. 1, 2010, which claims priority from Korean Patent Application No. 10-2009-0104426, filed on Oct. 30, 2009 in the Korean Intellectual Property Office, the disclosure of which is incorporated herein in its entirety by reference.

### BACKGROUND

1. Field

Apparatuses and methods consistent with exemplary embodiments relate to entropy encoding and decoding.

2. Description of the Related Art

Currently, high-resolution and high-quality video data are easily obtained due to the development of sensor systems. High-resolution and high-quality video data have large sizes and thus a video encoding or decoding technology is generally required to efficiently store the video data. Also, as the sizes of screens increase, a high-speed video encoding or decoding technology is demanded to process video data in real time.

A high-speed video encoding or decoding technology may be realized by processing a plurality of data groups in parallel. From among video decoding methods, an entropy decoding method may not be easily performed in parallel because symbols having a higher priority have to be decoded first in order to decode symbols having a lower priority.

### SUMMARY

Aspects of exemplary embodiments provide a method and apparatus for entropy encoding and decoding data groups in parallel according to classes in consideration of a decoding rate.

According to an aspect of an exemplary embodiment, there is provided an entropy encoding method including: generating bitstreams by dividing video data into a plurality of data groups, encoding each of the data groups so as to generate symbols, and performing entropy encoding on the symbols; classifying the generated bitstreams into a plurality of classes such that bitstreams of neighboring data groups are classified into different classes; determining, from among a plurality of segments divided from a datastream, segments to which one or more bitstreams of a same class are allocated based on decoding rates of the bitstreams; and outputting a datastream including bitstreams allocated to each segment.

The determining of the segments may include determining a decoding rate of each data group based on at least one of a total decoding time and a total number of symbols of the data group; and determining segments to which bitstreams of the data group are allocated based on the decoding rate of the data group, and one of the classes may correspond to each segment.

The classifying of the bitstreams may include respectively classifying first and second bitstreams that are continuous according to an encoding order of the data groups, into continuous first and second classes, and the determining of the segments may include storing the first bitstream of the first class in a first segment and storing the second bitstream of the second class in a second segment.

The determining of the segments may include determining a segment to which a first bitstream is allocated; and allocating a next bitstream of the first bitstream, which is classified into the same class as the first bitstream, to a remaining region of the determined segment other than a region allocated to the first bitstream.

The determining of the segments may include determining a first segment to which a bitstream of a first class is allocated; determining a second segment to which a bitstream of a second class is allocated; comparing decoding rates of the bitstreams of the first and second classes; and based on a comparison result, continuously allocating an excess portion of the bitstream of the first class, which is not allocated to the first segment, to a segment that is the most adjacent to the first segment from among segments other than segments already allocated to the second class.

Each segment may be allocated to one of the classes, and a total number of the classes may be a number of data groups entropy-decodable in parallel in one cycle.

The determining of the segments may include determining a first segment to which a first bitstream of a first class is allocated; and, if a size of a bitstream of a last symbol of the first bitstream is greater than that of a remaining region of the first segment, determining whether to separately allocate the bitstream of the last symbol to the remaining region of the first segment and a second segment corresponding to the first class.

If a plurality of data groups that are continuous according to an encoding order of data groups have the same encoding characteristics, the classifying of the bitstreams may include indexing the data groups having the same encoding characteristics as one predetermined virtual data group; and indexing a next data group of the data groups having the same encoding characteristics as a next virtual data group of the predetermined virtual data group.

The classifying of the bitstreams may include determining bitstreams of a current data group based on context regarding symbols of neighboring data groups from among data groups classified into the same class; and determining context regarding the current data group based on the determined bitstreams of the current data group.

According to an aspect of another exemplary embodiment, there is provided an entropy decoding method including: receiving a datastream including video data divided into a plurality of data groups and then encoded; determining, from among a plurality of segments divided from a datastream, segments to which one or more bitstreams of a same class are allocated based on a decoding rate of each data group, and parsing bitstreams of each data group from the segments; reading the parsed bitstreams according to a plurality of classes classified such that bitstreams of neighboring data groups are classified into different classes; and decoding the encoded video data by performing entropy decoding on read data groups in parallel.

The parsing may include allocating each segment to one of the classes and parsing bitstreams in parallel from segments allocated according to the classes, and the decoding may include performing entropy decoding in parallel on bitstreams of the read data groups according to the classes.

The parsing may include respectively parsing a first bitstream of a first class and a second bitstream of a second class, which are continuous according to a decoding order of the data groups, from first and second segments; and allocating the first segment to the first class and allocating the second segment to the second class.

The parsing may include parsing a first bitstream of a first class from a first segment; and parsing a second bitstream that is a next bitstream of the first bitstream and is classified into the first class, from a remaining region of the first segment other than a region allocated to the first bitstream.

The parsing may include parsing a bitstream of a first class from a first segment; parsing a bitstream of a second class from a second segment; comparing decoding rates of the bitstreams of the first and second classes; and based on a comparison result, continuously parsing an excess portion of the bitstream of the first class, which is not parsed from the first segment, from a segment that is the most adjacent to the first segment from among segments other than segments already allocated to the second class.

The parsing may include parsing a first bitstream of a first class from a first segment; and, if a size of a bitstream of a last symbol of the first bitstream is greater than that of a remaining region of the first segment, determining whether to separately parse the bitstream of the last symbol from the remaining region of the first segment and a second segment corresponding to the first class.

The parsing may include parsing a plurality of data groups indexed as a predetermined virtual data group, having the same encoding characteristics, and continuously encoded; and parsing a next data group of the data groups having the same encoding characteristics, which is indexed as a next virtual data group of the predetermined virtual data group.

The decoding may include determining bitstreams of a current data group based on context regarding symbols of neighboring data groups from among data groups read according to the classes and classified into the same class; and determining context regarding the current data group based on the determined bitstreams of the current data group.

According to an aspect of another exemplary embodiment, there is provided a video encoding apparatus including: an encoding unit which divides video data into a plurality of data groups and encodes each of the data groups so as to generate symbols; an entropy encoding performing unit which generates bitstreams by performing entropy encoding on the symbols; a bitstream storage which reconfigures the bitstreams by classifying the bitstreams into a plurality of classes such that bitstreams of neighboring data groups are classified into different classes, and determines, from among a plurality of segments divided from a datastream, segments to which one or more bitstreams of a same class are allocated based on decoding rates of the bitstreams; and an output unit which outputs a datastream including bitstreams allocated to each segment.

According to an aspect of another exemplary embodiment, there is provided a video decoding apparatus including: a reception unit which receives a datastream including video data divided into a plurality of data groups and then encoded; a bitstream read unit which determines, from among a plurality of segments divided from a datastream, segments to which one or more bitstreams of a same class are allocated based on a decoding rate of each data group, parses bitstreams of each data group from the segments, and reads the parsed bitstreams according to a plurality of classes classified such that bitstreams of neighboring data groups are classified into different classes; an entropy decoding performing unit which performs entropy decoding on read data groups in parallel and outputs the encoded video data; and a decoding unit which decodes the encoded video data.

According to an aspect of another exemplary embodiment, there is provided a computer readable recording medium having recorded thereon a computer program for executing the entropy encoding method.

According to an aspect of another exemplary embodiment, there is provided a computer readable recording medium having recorded thereon a computer program for executing the entropy decoding method.

According to an aspect of another exemplary embodiment, there is provided an entropy encoding method including: classifying bitstreams of data groups, which are generated by performing entropy encoding on a plurality of symbols of the data groups, into a plurality of classes such that bitstreams of neighboring data groups, among the plurality of data groups, are classified into different classes; determining, from among a plurality of segments divided from a datastream, segments to which one or more bitstreams of a same class are allocated based on decoding rates of the generated bitstreams; and outputting a datastream comprising bitstreams allocated to each segment according to the determining.

According to an aspect of another exemplary embodiment, there is provided an entropy decoding method including: determining bitstreams of a plurality of data groups from segments, of a datastream, to which one or more bitstreams of a same class are allocated based on decoding rates of the plurality of data groups; reading the determined bitstreams according to a plurality of classes classified such that bitstreams of neighboring data groups, among the plurality of data groups, are classified into different classes; and decoding the encoded video data by performing entropy decoding on read data groups in parallel.

### BRIEF DESCRIPTION OF THE DRAWINGS

The above and other features and advantages will become more apparent by describing in detail exemplary embodiments with reference to the attached drawings in which:

FIG. 1 is a block diagram of an entropy encoding apparatus, according to an exemplary embodiment;

FIG. 2 is a block diagram of an entropy decoding apparatus, according to an exemplary embodiment;

FIG. 3 is a block diagram of an H.264 system, according to an exemplary embodiment;

FIG. 4 is a diagram for describing an entropy encoding process in parallel;

FIG. 5 is a diagram for describing an entropy decoding process in parallel;

FIG. 6 is a conceptual diagram for describing a method of dividing a storing space into segments based on bitstreams of data groups, according to an exemplary embodiment;

FIGS. 7A through 7D are conceptual diagrams showing that bitstreams of data groups are allocated in an orderly manner to a storing space divided into segments, according to an exemplary embodiment;

FIG. 8 is a flowchart of an entropy encoding method, according to an exemplary embodiment;

FIG. 9 is a flowchart of an entropy decoding method, according to an exemplary embodiment;

FIG. 10 is a diagram for describing a bitstream reconfiguring process based on a decoding rate, according to an exemplary embodiment;

FIGS. 11A through 11D are diagrams for describing a bitstream parsing process based on a decoding rate, according to an exemplary embodiment;

FIG. 12 is a diagram for describing a parallel parsing and reading process according to an exemplary embodiment;

FIG. 13 is a diagram showing an exceptional case of reconfiguring and parsing bitstreams and a solution thereof, according to an exemplary embodiment;

FIGS. 14A and 14B are diagrams showing another exceptional case of reconfiguring and parsing bitstreams and a solution thereof, according to an exemplary embodiment;

FIG. 15 is a flowchart of an entropy encoding method based on a decoding rate, according to an exemplary embodiment; and

FIG. 16 is a flowchart of an entropy decoding method based on a decoding rate, according to an exemplary embodiment.

### DETAILED DESCRIPTION OF EXEMPLARY EMBODIMENTS

Hereinafter, exemplary embodiments will be described in detail with reference to the attached drawings.

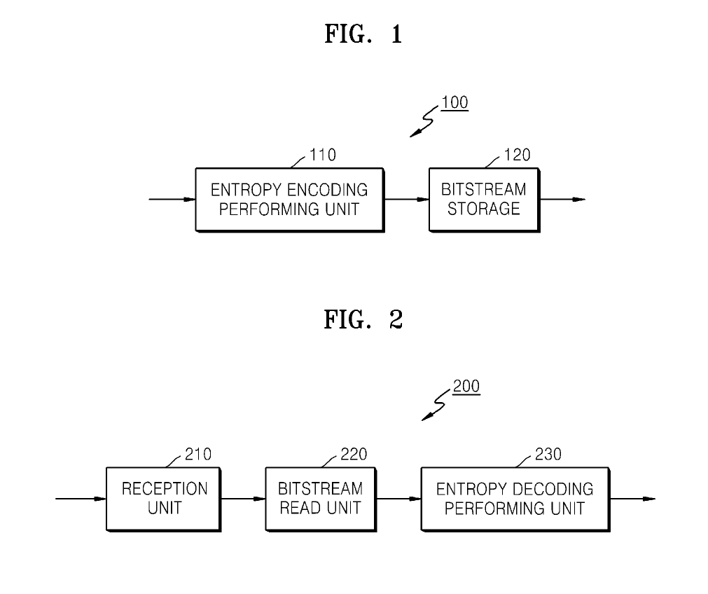

FIG. 1 is a block diagram of an entropy encoding apparatus 100, according to an exemplary embodiment.

Referring to FIG. 1, the entropy encoding apparatus 100 includes an entropy encoding performing unit 110 and a bitstream storage 120.

The entropy encoding performing unit 110 receives a plurality of symbols of data groups, performs entropy encoding, and thus generates bitstreams of the data groups.

A data group refers to a unit in which video data is encoded. An example of the data group may be a macroblock. However, the data group is not limited thereto.

The plurality of symbols input to the entropy encoding apparatus 100 are resultant data generated by a motion estimation unit which estimates motion between frames of input video data, a motion compensation unit which performs inter prediction by using motion information between the frames, an intra prediction unit which performs intra prediction by using information of neighboring pixels of one frame from among the frames, and a transformation and quantization unit which performs frequency transformation and quantization on residual video data generated by performing prediction encoding.

The symbols may include quantized coefficients of the residual video data of the data groups, encoding information and the motion information. The encoding information may include information such as a prediction mode representing an encoding method and a size of a data group.

The entropy encoding may be performed by using a context-based adaptive variable-length coding (CAVLC) method, a context-based adaptive binary arithmetic coding (CABAC) method, or the like.

The bitstream storage 120 stores the bitstreams generated by the entropy encoding performing unit 110 in a storing space divided into a plurality of segments. The length of each of the plurality of segments is set in advance and the storing space is divided into equal-length segments. The bitstream storage 120 stores the bitstreams by allocating the bitstreams to respective segments according to properties of the bitstreams.

The properties of the bitstreams may be based on an encoding order of the data groups. Also, according to the properties of the bitstreams, the bitstreams may be classified into a plurality of groups. According to an exemplary embodiment, the type of a segment is determined based on a property of a bitstream allocated to the segment and thus the storing space may be divided into the plurality of segments corresponding to a plurality of types. A number of types of the plurality of segments may correspond to a number of bitstreams that are entropy-decodable in parallel in one cycle.

The bitstream storage 120 determines that bitstreams of neighboring data groups in the encoding order of the data groups have different properties, and thus does not allocate bitstreams of neighboring data groups to the same segment. In other words, the bitstream storage 120 allocates bitstreams of neighboring data groups in the encoding order of the data groups to different segments among the plurality of segments.

The bitstream storage 120 may search for a segment to which a bitstream is allocated. When a segment to which a bitstream of a predetermined data group is searched, if a bitstream of a data group having a neighboring processing order is stored in a currently used segment, the bitstream of the predetermined data group may be allocated to a new segment that is not currently used.

In more detail, the bitstream storage 120 may respectively allocate sequential first and second bitstreams in the encoding order of the data groups, to sequential first and second segments among the plurality of segments.

If the length of the first bitstream is less than that of the first segment, a next bitstream having the same property as the first bitstream may be allocated to the first segment from a point where the storing of the first bitstream is completed.

Also, if the length of the second bitstream is greater than that of the second segment, the second bitstream may be continuously allocated to a plurality of neighboring segments from the second segment, among the plurality of segments. In this case, a next bitstream of the second bitstream in the encoding order of the data groups may be allocated to a new segment that is not a segment in which the storing of the second bitstream is completed, among the plurality of segments.

The bitstream storage 120 may reconfigure the order of the bitstreams to be stored or output.

The entropy encoding apparatus 100 reconfigures a storing order of bitstreams generated based on data groups by performing entropy encoding and outputs the bitstreams such that a decoding terminal may entropy-decode the bitstreams in parallel. Accordingly, when video data having a resolution of a high-definition (HD) or an ultra-definition (UD) level is encoded/decoded, entropy decoding may be performed at high speed.

FIG. 2 is a block diagram of an entropy decoding apparatus 200, according to an exemplary embodiment.

Referring to FIG. 2, the entropy decoding apparatus 200 includes a reception unit 210, a bitstream read unit 220 and an entropy decoding performing unit 230.

The reception unit 210 may receive a plurality of entropy-encoded bitstreams of data groups. A storing order of the received bitstreams is reconfigured according to the data groups. For example, bitstreams of sequential data groups in the decoding order of the data groups are not sequentially stored. Accordingly, the reading order of bitstreams of the data groups may be determined in consideration of a decoding order of the data groups.

The bitstream read unit 220 reads the bitstreams received by the reception unit 210 by identifying the bitstreams. Since the bitstreams are stored in an orderly manner in segments divided according to properties of the bitstreams, the bitstream read unit 220 searches for a segment to which a desired bitstream is allocated, in order to read the desired bitstreams.

The bitstream read unit 220 reads bitstreams of neighboring data groups in the decoding order of the data groups, from different segments. In more detail, the bitstream read unit 220 reads sequential first and second bitstreams in the decoding order of the data groups from sequential first and second segments. If the length of the first bitstream is less than that of the first segment, a next bitstream having the same property as the first bitstream may be read from the first segment from a point where the storing of the first bitstream is completed.

Also, if the length of the second bitstream is greater than that of the second segment, the second bitstream may be continuously read from a plurality of segments, including the second segment and neighboring segments from the second segment. In this case, a next bitstream of the second bitstream in the encoding order of the data groups may be read from a new segment that is not the segment in which the storing of the second bitstream is completed.

The entropy decoding performing unit 230 performs entropy decoding in parallel on the bitstreams read by the bitstream read unit 220. The entropy decoding performing unit 230 may perform entropy decoding in parallel on a number of bitstreams corresponding to the number of types of the segments in one cycle. For example, if the bitstreams are allocated to N number of segments according to the properties of the bitstreams, the entropy decoding performing unit 230 may perform parallel processing on the N number of segments.

Symbols of the data groups, which are generated when the entropy decoding performing unit 230 performs entropy decoding, may include quantized coefficients of residual video data of the data groups, encoding information and motion information.

The entropy decoding apparatus 200 may further include an inverse quantization and inverse transformation unit (not shown) which restores video data of the data groups by performing inverse quantization and inverse frequency transformation on the quantized coefficients of the residual video data of the data groups, a motion compensation unit (not shown) which performs inter prediction by using the motion information and the residual video data of the data groups, an intra prediction unit (not shown) which performs intra prediction on the video data of the data groups, and a deblocking performing unit (not shown) which restores original video data by performing deblocking filtering on the video data of the data groups and the video data on which the intra prediction and motion compensation are performed. The symbols may be decoded by the inverse quantization and inverse transformation unit, a motion estimation unit, the motion compensation unit, the intra prediction unit and the deblocking performing unit into the original video data.

The entropy decoding apparatus 200 may receive a plurality of bitstreams of data groups, which are generated by performing entropy encoding and of which a storing order is reconfigured, and may perform entropy decoding in parallel on the bitstreams of the data groups. Accordingly, entropy decoding may be performed at high speed on video data having a resolution of an HD or a UD level. An overall speed of video decoding may be increased by performing entropy decoding at high speed.

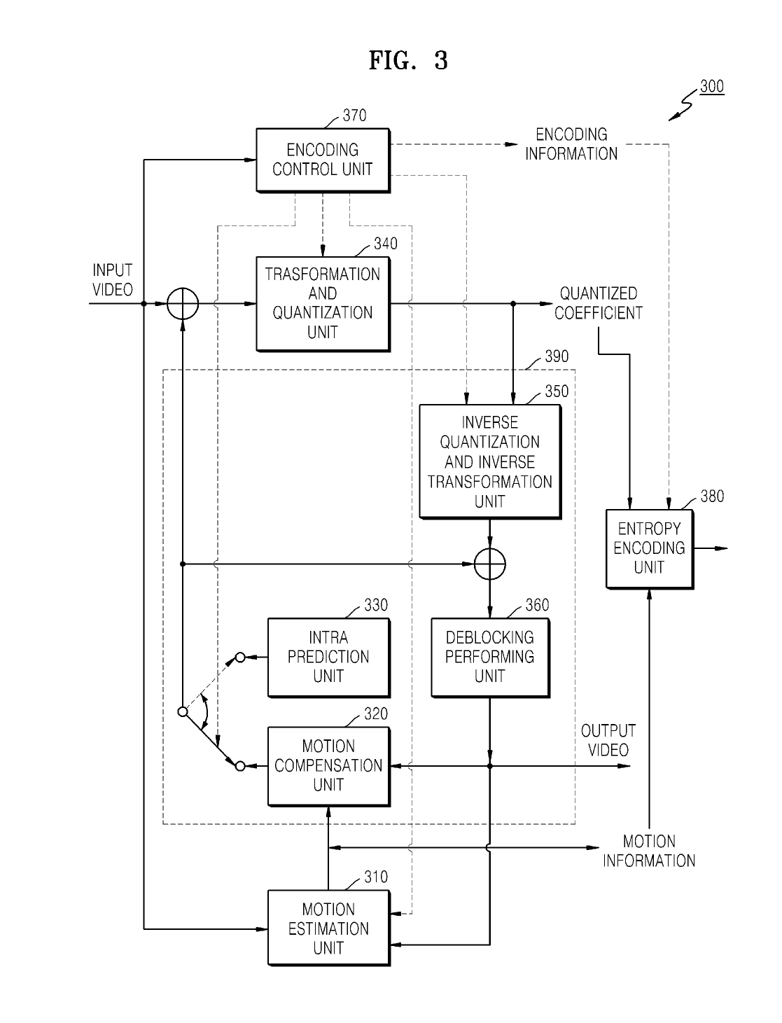

FIG. 3 is a block diagram of an H.264 system according to an exemplary embodiment.

Referring to FIG. 3, a video encoding module 300 the H.264 system includes a motion estimation unit 310, a motion compensation unit 320, an intra prediction unit 330, a transformation and quantization unit 340, an inverse quantization, and inverse transformation unit 350, a deblocking performing unit 360, an encoding control unit 370 and an entropy encoding unit 380.

The motion estimation unit 310 estimates motion between frames of input video data. Then, the motion compensation unit 320 which performs inter prediction between the frames by using motion information and the intra prediction unit 330 which performs intra prediction by using information of neighboring pixels of one frame selectively operate by control of the encoding control unit 370. The transformation and quantization unit 340 performs frequency transformation and quantization on the input video data and residual video data generated by performing prediction encoding, and the entropy encoding unit 380 encodes quantized coefficients into a bitstream having high transmission efficiency.

The inverse quantization and inverse transformation unit 350 generates residual video data by restoring the quantized coefficients into spatial domain data, and restoration video data is generated by reflecting the prediction encoding result to the residual video data. The deblocking performing unit 360 generates output video data by performing quantization and transformation in units of a block so as to reduce a blocking effect of the restoration video data.

The encoding control unit 370 controls the encoding process overall. For example, the encoding control unit 370 may output, as encoding information, information for controlling the transformation and quantization unit 340 and the inverse quantization and inverse transformation unit 350 and information for controlling the motion estimation unit 310.

The motion information generated by the motion estimation unit 310, the quantized coefficients of the residual video data which are generated by the transformation and quantization unit 340, and the various types of encoding information output from the encoding control unit 370 are output from the entropy encoding unit 380 in the form of a bitstream that is the closest to an entropy state.

A decoding process of the H.264 system may be performed by a video decoding unit 390 including the inverse quantization and inverse transformation unit 350, the deblocking performing unit 360, the motion compensation unit 320 and the intra prediction unit 330. Entropy-decoded symbols of a received bitstream are input to the inverse quantization and inverse transformation unit 350. The deblocking performing unit 360 generates output video data by reducing a blocking effect, as decoded ultimate video data.

If the entropy encoding apparatus 100 illustrated in FIG. 1 uses an H.264 encoding method, the entropy encoding apparatus 100 may be used as the entropy encoding unit 380. Also, if the entropy decoding apparatus 200 illustrated in FIG. 2 uses an H.264 decoding method, symbols entropy-decoded in parallel may be decoded by the video decoding module 390.

However, it is understood that encoding/decoding methods of the entropy encoding apparatus 100 and the entropy decoding apparatus 200 are not limited to the H.264 encoding/decoding methods in other exemplary embodiments.

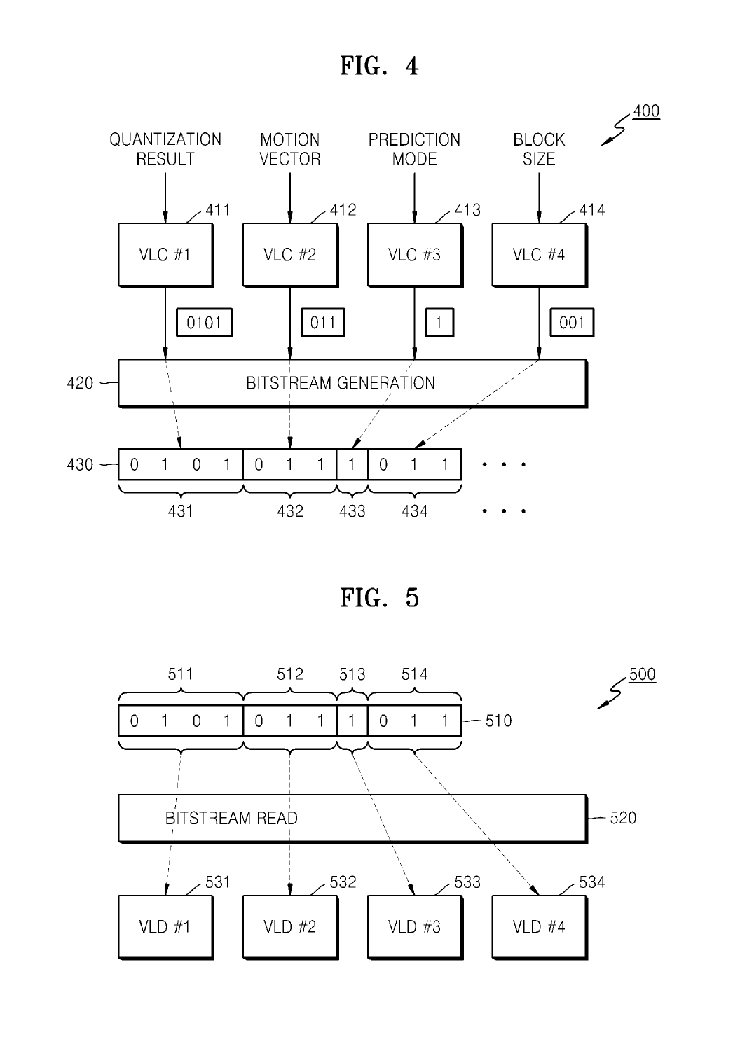

FIG. 4 is a diagram for describing an entropy encoding process 400 in parallel.

Referring to FIG. 4, the entropy encoding process 400 uses a variable-length coding (VLC) method. A quantization result of residual video data, a motion vector, a prediction mode and block size information may be entropy-encoded in parallel respectively by first through fourth VLC units 411 through 414. For example, the quantization result of the residual video data may be information regarding a level and a run value, the prediction mode may represent an intra mode, an inter mode, a skip mode or the like, and the block size information may represent a block size such as 4×4, 8×8 or 16×16.

The first VLC unit 411 may generate a first bitstream 431 ('0101′), the second VLC unit 412 may generate a second bitstream 432 (011′), the third VLC unit 413 may generate a third bitstream 433 (1′), and the fourth VLC unit 414 may generate a fourth bitstream 434 ('001′). Since the first through fourth VLC units 411 through 414 may perform entropy encoding in parallel, the bitstreams 431 through 434 may be generated in the same cycle.

The bitstreams 431 through 434 respectively generated by the first through fourth VLC units 411 through 414 are formed into one bitstream 430 ('01010111011′) by performing a bitstream generation process 420.

Accordingly, since different types of resultant data of one data group may be processed in parallel, bitstreams according to data types of one data group may be simultaneously generated in one cycle. Also, in the entropy encoding process 400, since the sizes of the bitstreams 431 through 434 respectively generated by the first through fourth VLC units 411 through 414 may be known, the bitstreams 431 through 434 generated according to input data may be arranged in a predetermined order and then may be simultaneously generated into an output bitstream in the bitstream generation process 420.

FIG. 5 is a diagram for describing an entropy decoding process 500 in parallel.

Referring to FIG. 5, in the entropy decoding process 500, although a received bitstream 510 includes first through fourth bitstreams 511 through 514 having different types of information, unless a first bitstream 511 having a higher priority is read and then is entropy-decoded by a first variable-length decoding (VLD) unit 531 in a bitstream read process 520, second through fourth bitstreams 512 through 514 having lower priorities may not be read. Accordingly, the first through fourth bitstreams 511 through 514 may not be easily read in parallel.

As such, entropy decoding of the first VLD unit 531 and entropy decoding of second through fourth VLD units 532 through 534 may not be performed in parallel.

Accordingly, although entropy encoding may be performed in parallel on one data group having different data types, in an entropy decoding process, a start point where bitstreams having lower priorities are stored may not be easily found and thus parallel processing may not be easily performed.

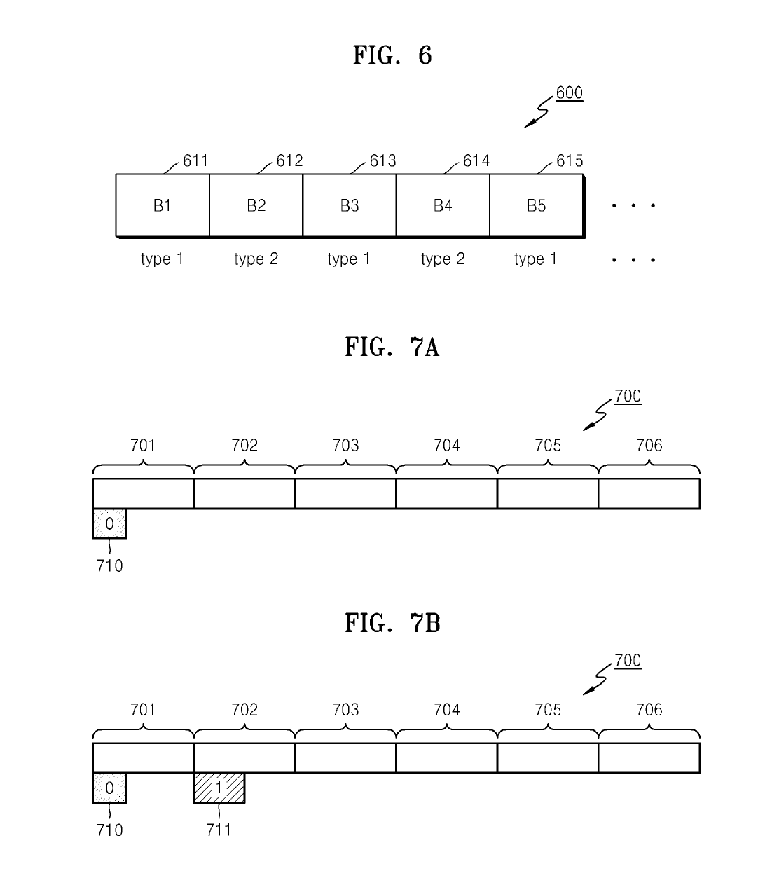

FIG. 6 is a conceptual diagram for describing a method of dividing a storing space into segments based on bitstreams of data groups, according to an exemplary embodiment.

Referring to FIG. 6, an entropy-encoded bitstream 600 includes first through fifth bitstreams 611 through 615 of data groups. For example, if a storing space of the entropy-encoded bitstream 600 is divided into two-type segments, properties of the first through fifth bitstreams 611 through 615 may be classified into two types. Bitstreams of different-type data groups may be allocated to different-type segments.

The entropy encoding apparatus 100 illustrated in FIG. 1 may use an encoding or decoding order of the data groups (hereinafter, the encoding order will be representatively described) as properties of the first through fifth bitstreams 611 through 615 to determine a reconfiguration order of the first through fifth bitstreams 611 through 615. If the storing space is divided into two-type segments, the encoding order of the data groups may be classified into two types. For example, the bitstream 600 may classify the encoding order of the data groups into odd-number and even-number processing orders of the data groups.

B1 through B5 represent the encoding order of the data groups. Accordingly, the first, third, and fifth bitstreams 611, 613 and 615 may be classified as first-type bitstreams and the second and fourth bitstreams 612 and 614 may be classified as second-type bitstreams. The bitstream storage 120 illustrated in FIG. 1 may allocate the first-type bitstreams to first-type segments, and the second-type bitstreams to second-type segments. Also, the bitstream read unit 220 illustrated in FIG. 2 may read the first-type bitstreams from the first-type segments, and the second-type bitstreams from the second-type segments.

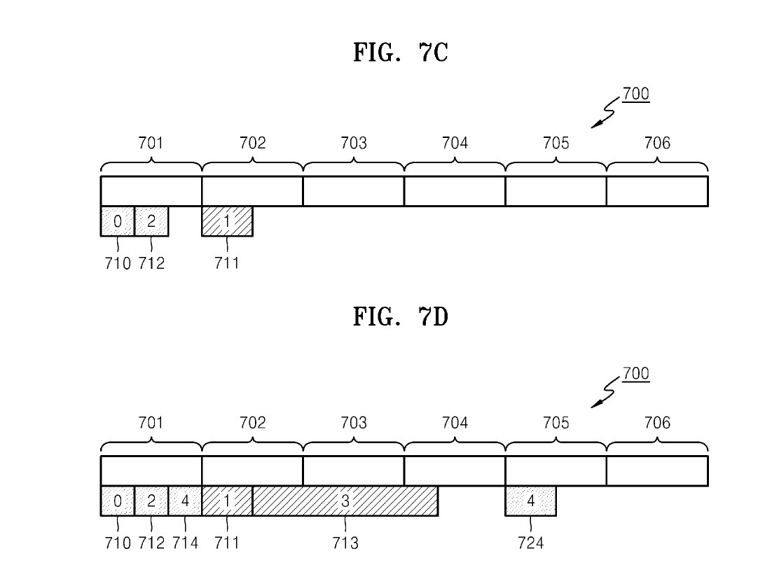

FIGS. 7A through 7D are conceptual diagrams showing that bitstreams of data groups are allocated in an orderly manner to a storing space divided into segments, according to an exemplary embodiment.

FIG. 7A through 7D show how the bitstream storage 120 illustrated in FIG. 1 reconfigures and stores entropy-encoded bitstreams of data groups. Also, the bitstream read unit 220 illustrated in FIG. 2 may identify bitstreams of data groups from a received bitstream and may read the bitstreams in an encoding order, as illustrated in FIG. 7A through 7D.

Referring to FIG. 7A, a storing space 700 is divided into first through sixth segments 701 through 706. Properties of bitstreams of data groups may be classified into a first property of bitstreams of data groups having even order numbers and a second property of bitstreams of data groups having odd order numbers, in an encoding order of the data groups. A first bitstream 710 of a data group having order number 0, i.e., an initial bitstream, may be allocated to the first segment 701. The first segment 701 to which the first bitstream 710 having the first property is allocated may be classified as a first-type segment.

Referring to FIG. 7B, a second bitstream 711 of a data group having order number 1 is a bitstream of a neighboring data group of the data group of the first bitstream 710 according to the encoding order of the data groups, and thus may not be allocated to the first segment 701 to which the first bitstream 710 is allocated. Accordingly, the second bitstream 711 may be allocated to the second segment 702. The second segment 702 to which the second bitstream 711 having the second property is allocated may be classified as a second-type segment.

If the entropy decoding performing unit 230 illustrated in FIG. 2 includes first and second entropy decoding units, the first entropy decoding unit may perform entropy decoding on bitstreams having the first property, and the second entropy decoding unit may perform entropy decoding on bitstreams having the second property in parallel with the first entropy decoding unit.

Referring to FIG. 7C, a third bitstream 712 of a data group having order number 2 is a bitstream of a data group having the first property like the first bitstream 710, and thus may be allocated to the same-type segment as that to which the first bitstream 710 is allocated (i.e., the first segment 701). Furthermore, since the first segment 701 has a remaining space in addition to the storing space of the first bitstream 710, the third bitstream 712 may be allocated to the first segment 701.

In this case, since the first and third bitstreams 710 and 712 are adjacent to each other, before the second entropy decoding unit completes the entropy decoding of the second bitstream 711 having the second property, the first entropy decoding unit may entropy-decode both the first and third bitstreams 710 and 712.

Referring to FIG. 7D, a fourth bitstream 713 of a data group having order number 3 is a bitstream of a data group having the second property, and thus may be allocated to the same-type segment as that to which the second bitstream 711 having the second property is allocated (i.e., the second segment 702). Furthermore, since the second segment 702 has a remaining space in addition to the storing space of the second bitstream 711, the fourth bitstream 713 may be allocated to the second segment 702. However, since the length of the fourth bitstream 713 is greater than that of the remaining space of the second segment 702, the fourth bitstream 713 may be continuously allocated to the neighboring third and fourth segments 703 and 704. The third and fourth segments 703 and 704 to which the fourth bitstream 713 having the second property is allocated may be classified as second-type segments.

A bitstream of a data group having order number 4 is a bitstream of a data group having the first property, and thus may be allocated to the same-type segment as that to which the first and third bitstreams 710 and 712 having the first property are allocated. Furthermore, since the first segment 701 has a remaining space in addition to the storing space of the first and third bitstreams 710 and 712, a partial fifth bitstream 714 of the bitstream of the data group having order number 4 may be allocated to the first segment 701. However, since the length of the bitstream of the data group having order number 4 is greater than that of the remaining space of the first segment 701, a remaining fifth bitstream 724 of the bitstream of the data group having order number 4 is allocated to a new segment, i.e., the fifth segment 705.

In this case, since the second through fourth segments 702 through 704 are second-type segments, a bitstream having the first property may not be allocated thereto. Accordingly, the remaining fifth bitstream 724 may be allocated to the fifth segment 705 that is the closest segment to the first segment 701, i.e., a first-type segment, from among segments that are not classified as second-type segments.

In this manner, the bitstream storage 120 illustrated in FIG. 1 may allocate bitstreams having the first property and bitstreams having the second property to different-type segments. As such, the bitstream read unit 220 illustrated in FIG. 2 may read the bitstreams having the first property from first-type segments, and the bitstreams having the second property from second-type segments.

Also, before knowing that the storing of the fourth bitstream 713 is completed in the fourth segment 704, it may not be identified (e.g., by the bitstream storage 120) that a segment to which the remaining fifth bitstream 724 of the bitstream of the data group having order number 4 is the fifth segment 705. In other words, before the fourth bitstream 713 having a higher priority is read according to a decoding order, a location from which the remaining fifth bitstream 724 having a lower priority is read may not be determined.

Accordingly, although the first bitstream 710 having the first property and the second bitstream 711 having the second property may be processed in the same cycle and the third bitstream 712 having the first property and the fourth bitstream 713 having the second property may be processed in the same cycle according to a parallel entropy decoding order, before a cycle for processing the fourth bitstream 713 having the second property is terminated, entropy decoding of the bitstream of the data group having order number 4, which has the first property, may not be completed.

When the first entropy decoding unit performs entropy decoding on the third bitstream 712 of the data group having order number 2 and the second entropy decoding unit performs entropy decoding on the fourth bitstream 713 of the data group having order number 3 in parallel, if the processing of the third bitstream 712 is completed first, although the processing of the fourth bitstream 713 by the second entropy decoding unit is not completed, the first entropy decoding unit may start to process the bitstream of the data group having order number 4. In this case, although the processing of the fourth bitstream 713 is not completed, the partial fifth bitstream 714 of the bitstream of the data group having order number 4 may be read and entropy-decoded. However, since the location from which the remaining fifth bitstream 724 of the bitstream of the data group having order number 4 is read is not determined, the entropy decoding of the bitstream of the data group having order number 4 may be paused until the processing of the fourth bitstream 713 is completed in an exemplary embodiment.

Alternatively, according to another exemplary embodiment, when the first entropy decoding unit performs entropy decoding on the third bitstream 712 of the data group having order number 2 and the second entropy decoding unit performs entropy decoding on the fourth bitstream 713 of the data group having order number 3 in parallel, although the processing of the third bitstream 712 is completed first, the first entropy decoding unit may be set in advance not to start to process the bitstream of the data group having order number 4 until the processing of the fourth bitstream 713 is completed.

Although two-type bitstreams are allocated to two-type segments in FIGS. 6 and 7A through 7D, it is understood that another exemplary embodiment is not limited thereto. For example, according to another exemplary embodiment, the entropy encoding apparatus 100 and the entropy decoding apparatus 200 allow entropy decoding to be performed in parallel on N number of bitstreams allocated to N-type segments (where N is a natural number equal to or greater than three). In this case, bitstreams of data groups having order numbers that increase by N may be allocated to one segment.

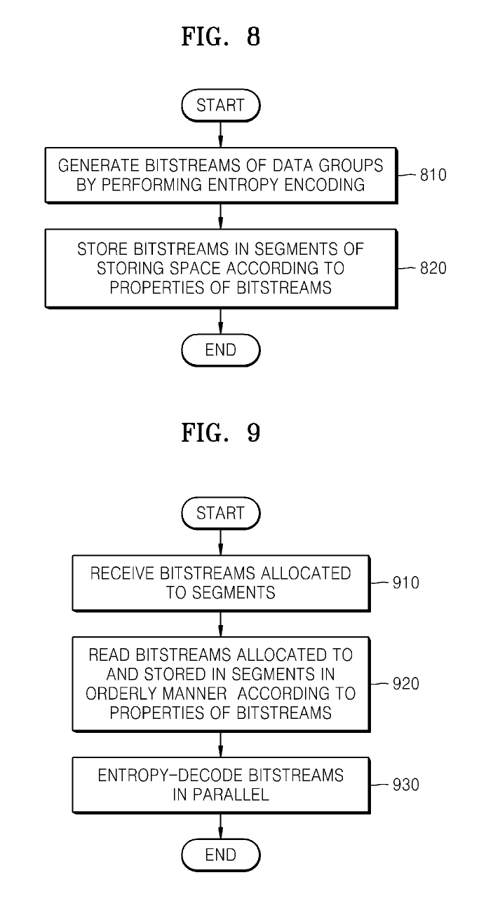

FIG. 8 is a flowchart of an entropy encoding method, according to an exemplary embodiment.

Referring to FIG. 8, in operation 810, bitstreams of data groups are generated by performing entropy encoding on a plurality of symbols of data groups.

In operation 820, the generated bitstreams are allocated to and stored in a plurality of divided segments of a storing space of the bitstreams, according to properties of the bitstreams. Bitstreams of neighboring data groups in an encoding order of the data groups are allocated to different segments.

The properties of the bitstreams are related to the encoding order of the data groups, and bitstreams of neighboring data groups in the encoding order of the data groups may have different properties. The bitstreams may be classified into a plurality of data groups according to the properties of the bitstreams. The type of a segment is classified according to a property of a bitstream allocated to the segment, and the number of types of the segments corresponds to the number of bitstreams that may be entropy-decoded in parallel in one cycle.

FIG. 9 is a flowchart of an entropy decoding method, according to an exemplary embodiment.

Referring to FIG. 9, in operation 910, a plurality of bitstreams of data groups, which are allocated to a plurality of segments, are received. A storing order of the received bitstreams is reconfigured according to the data groups. The reading order of the bitstreams may be determined in consideration of a decoding order of the data groups.

In operation 920, the bitstreams allocated in an orderly manner to the segments according to properties of the bitstreams are read. Bitstreams of neighboring data groups in the decoding order of the data groups may be read from different segments.

In operation 930, the read bitstreams are entropy-decoded in parallel. In every parallel processing cycle, a number of bitstreams corresponding to the number of types of the segments may be entropy-decoded in parallel. For example, if the bitstreams are allocated to N-type segments according to the properties of the bitstreams, entropy decoding may be performed in parallel on N number of segments in one cycle, where N is a natural number greater than or equal to 2.

According to an exemplary embodiment, a storing order of bitstreams generated by performing entropy encoding is reconfigured according to data groups. An entropy decoding apparatus may perform entropy decoding in parallel on a plurality of bitstreams of data groups by reading the bitstreams in a parallel entropy decoding order. Accordingly, entropy decoding may be performed at high speed on video data having a resolution of an HD or a UD level.

A process of reconfiguring bitstreams based on a decoding rate by the entropy encoding apparatus 100 illustrated in FIG. 1 will now be described in detail.

The entropy encoding apparatus 100 transmits a datastream including bitstreams reconfigured according to a predetermined rule. In order to parse the bitstreams from the received datastream and to reconfigure the bitstreams to their original state, the entropy decoding apparatus 200 illustrated in FIG. 2 reads the bitstreams according to the rule used by the entropy encoding apparatus 100 to reconfigure the bitstreams.

Also, in order to allow the entropy decoding apparatus 200 to parse data groups in parallel at a maximum speed, the entropy encoding apparatus 100 may allocate to neighboring segments initially parsable data groups from among data groups to be parsed in parallel.

Accordingly, the entropy encoding apparatus 100 may form a datastream for transmitting bitstreams by reconfiguring the bitstreams based on a decoding rate of bitstreams of each data group. The entropy decoding apparatus 200 may parse, from the received datastream, the bitstreams reconfigured based on a decoding rate of bitstreams of each data group.

A decoding rate includes a speed of parsing symbols extracted from a bitstream, and may comprehensively include a decoding rate of symbols.

The entropy encoding apparatus 100 performs entropy encoding on symbols generated by dividing video data into a plurality of data groups and encoding each of the data groups. The entropy encoding apparatus 100 reconfigures bitstreams generated by performing entropy encoding, stores the bitstreams in a datastream, and outputs the datastream.

In more detail, the entropy encoding performing unit 110 of the entropy encoding apparatus 100 performs entropy encoding on symbols of each data group and generates bitstreams.

The bitstream storage 120 receives and stores the bitstreams generated by the entropy encoding performing unit 110 in a datastream. The bitstream storage 120 may divide the datastream into a plurality of segments and may allocate one or more bitstreams to each segment.

The bitstream storage 120 classifies the bitstreams into a plurality of classes. Bitstreams of neighboring data groups are classified into different classes. For example, first and second bitstreams that are continuous according to an encoding order of data groups may be respectively classified into continuous first and second classes. The first bitstream of the first class may be stored in a first segment and the second bitstream of the second class may be stored in a second segment.

Since a data group of a predetermined class is allocated to each segment, each segment may correspond to one of a plurality of classes. A total number of classes may be the number of data groups of different classes entropy-decodable in parallel in one cycle of the entropy decoding apparatus 200.

The bitstream storage 120 may determine a segment to which bitstreams of a data group are allocated based on a decoding rate of the data group. A decoding time may be expected according to at least one of the type and the number of symbols of the data group. The bitstream storage 120 may determine a decoding rate of each data group based on at least one of a total decoding time and a total number of symbols of the data group. A decoding time according to the type of symbols may include a time for parsing the symbols in a decoding process.

The bitstream storage 120 may determine a segment to which each bitstream is allocated based on a decoding rate of the bitstream. Based on decoding rates of bitstreams, bitstreams of one class may be allocated to segments corresponding to the same class, and bitstreams of the same class may be allocated to one segment.

Since bitstreams are reconfigured by the bitstream storage 120 in such a way that bitstreams of the same class are allocated to each segment of a datastream, the entropy encoding apparatus 100 may output a datastream including the bitstreams reconfigured by the bitstream storage 120.

A process of allocating bitstreams of a predetermined class to a segment by the bitstream storage 120 will now be described in detail. The bitstream storage 120 may allocate a current bitstream of a predetermined class to a region of a segment and may allocate a next bitstream of the current bitstream, which is classified into the same class as the current bitstream, to a remaining region of the segment other than the region allocated to the current bitstream.

In order to determine segments to which bitstreams of different classes are allocated, a decoding rate of bitstreams of a current class may be compared to that of bitstreams of another class. Decoding rates of classes to be parsed at the same time in parallel may be compared. Based on the comparison result, an excess portion of a current bitstream which is not allocated to a current segment may be continuously allocated to a neighboring segment of the current segment. In this case, the excess portion of the current bitstream may be continuously allocated to a segment that is the most adjacent to the current segment from among segments other than segments already allocated to a class other than the current class.

As the comparison result, if the current bitstream is completely decoded first, the excess portion of the current bitstream may be allocated to a segment that is the most adjacent and immediately next to the current segment. Otherwise, if a bitstream of another class is completely decoded prior to the current bitstream, the excess portion of the current bitstream may be allocated to a next segment of the current segment, which is not allocated to another class.

If the size of a bitstream of a last symbol of a current bitstream is greater than that of a remaining region of a current segment to which the current bitstream is allocated, the bitstream storage 120 may determine whether to separately allocate the bitstream of the last symbol to the remaining region of the current segment and a next segment corresponding to a current class. The bitstream storage 120 may determine to allocate the whole bitstream of the last symbol of the current bitstream to the next segment and not to the remaining region of the current segment.

If a plurality of data groups that are continuous according to an encoding order of data groups have the same encoding characteristics, the bitstream storage 120 may index the data groups having the same encoding characteristics as one predetermined virtual data group. Also, the bitstream storage 120 may index a next data group of the data groups having the same encoding characteristics as a next virtual data group of the predetermined virtual data group.

The entropy encoding apparatus 100 may perform entropy encoding by using a CABAC method. Also, if the entropy encoding apparatus 100 uses a CAVLC method, the bitstream storage 120 may determine bitstreams of a current data group based on context regarding symbols of neighboring data groups from among data groups classified into the same class. Furthermore, context regarding the current data group may be determined based on the determined bitstreams of the current data group, and may be used to perform entropy encoding on symbols of a next data group.

A process of parsing and decoding bitstreams reconfigured based on a decoding rate of the bitstreams by the entropy decoding apparatus 200 illustrated in FIG. 2 will now be described in detail.

The reception unit 210 of the entropy decoding apparatus 200 receives and transmits a datastream to the bitstream read unit 220. The bitstream read unit 220 reads bitstreams of one or more data groups from each segment of the datastream. Reading of a bitstream may include parsing of symbols. The bitstream read unit 220 may read bitstreams of each data group.

The entropy decoding performing unit 230 may perform entropy decoding on each data group read by the bitstream read unit 220 and may generate symbols of each data group including quantized coefficients of image residuals, encoding information, and motion information. Video data may be decoded by performing a video decoding process using encoded video data and symbols.

With regard to the structure of a datastream, meanings of data groups, classes, segments, bitstreams, etc., are already described above with reference to the entropy encoding apparatus 100.

Since data groups are classified into a plurality of classes, and bitstreams of neighboring data groups are classified into different classes, the bitstream read unit 220 may parse and read bitstreams of data groups according to classes. The bitstream read unit 220 may determine segments from which bitstreams of data groups are of the same class. From a segment allocated to a predetermined class, bitstreams of data groups of the same class may be parsed.

The bitstream read unit 220 may determine segments to which bitstreams of one or more data groups of the same class are allocated based on a decoding rate of each data group. For example, the bitstream read unit 220 may determine at least one segment to which a current data group is allocated based on a decoding rate determined according to a total decoding time or a total number of symbols of the current data group.

Since each segment corresponds to one of classes, the bitstream read unit 220 may determine segments corresponding to each class. Also, the bitstream read unit 220 may parse bitstreams in parallel from the segments determined according to classes. As such, the entropy decoding performing unit 230 may also perform entropy decoding in parallel on bitstreams of data groups of different classes.

A process of reading bitstreams of a predetermined class from segments by the bitstream read unit 220 will now be described in detail.

The bitstream read unit 220 may respectively parse a first bitstream of a first class and a second bitstream of a second class, which are continuous according to a decoding order of data groups, from first and second segments. In this case, the first segment is allocated to the first class and the second segment is allocated to the second class.

When the first bitstream of the first class is parsed from the first segment, the bitstream read unit 220 may parse the first bitstream from a region of the first segment and may parse a next bitstream of the first bitstream, which is classified into the first class, from a remaining region of the first segment other than the region allocated to the first bitstream.

When a current bitstream of a current class is parsed from a current segment, in order to determine segments from which bitstreams of different classes are parsed, the bitstream read unit 220 may compare a decoding rate of bitstreams of the current class to a decoding rate of bitstreams of another class. Based on the comparison result, an excess portion of the current bitstream which is not parsed from the current segment may be continuously parsed from a neighboring segment next to the current segment. In this case, the excess portion of the current bitstream may be continuously parsed from a segment that is the most adjacent to the current segment from among segments other than segments already allocated to a class other than the current class.

If a first bitstream of a first class is parsed from a first segment, the size of a bitstream of a last symbol of the first bitstream may be greater than that of a remaining region of the first segment. In this case, the bitstream read unit 220 may determine whether to separately parse the bitstream of the last symbol from the remaining region of the first segment and a next segment corresponding to the first class. The bitstream read unit 220 may determine a parsing method of the last symbol based on whether the bitstream of the last symbol is separately allocated to the remaining region of the first segment and the next segment allocated to the first class in an encoding process.

If a plurality of data groups that are continuous according to a decoding order of data groups have the same encoding characteristics, the data groups having the same encoding characteristics may be indexed as one predetermined virtual data group. In this case the bitstream read unit 220 may restore a plurality of continuous original data groups from the predetermined virtual data group. Also, the bitstream read unit 220 may parse a next original data group of the original data groups having the same encoding characteristics from a next virtual data group of the predetermined virtual data group.

The entropy decoding apparatus 200 may perform entropy decoding by using a CABAC method. Also, if the entropy decoding apparatus 200 uses a CAVLC method, the entropy decoding performing unit 230 may determine bitstreams of a current data group based on context regarding symbols of neighboring data groups, from among data groups read from each class and classified into the same class. The entropy decoding performing unit 230 may determine context regarding the current data group based on the bitstreams of the current data group, and may determine bitstreams of a next data group based on the context regarding the current data group.

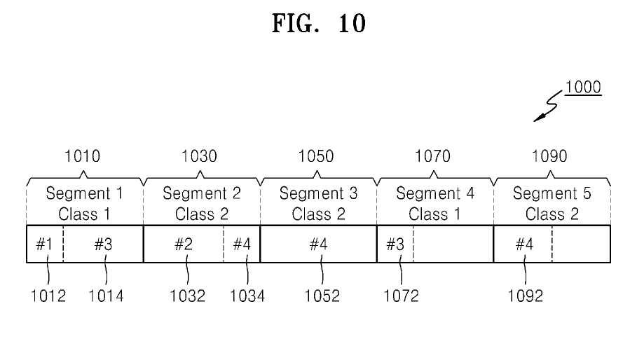

A bitstream reconfiguring and reading process based on a decoding rate will now be described in detail with reference to FIGS. 10 through 13.

A class of a data group may be determined according to a location and characteristics of the data group. A plurality of classes may be determined based on an encoding order of data groups, or data groups having the same encoding characteristics may be classified into the same class.

An example of a data group may include a macroblock. Macroblocks may be classified sequentially into different classes according to an encoding order. When M is an integer equal to or greater than 1, if a total number of classes is M, first through Mth macroblocks may be respectively classified into first through Mth classes, and (M+1)th through 2Mth macroblocks may be respectively classified into the first through Mth classes again. Accordingly, when i, N, and k are integers equal to or greater than 0, an (i×N+k)th macroblock may be classified into a kth class.

In FIGS. 10 through 13, for convenience of explanation, it is assumed that data groups are classified into two classes and, according to an encoding/decoding order of data groups, odd-numbered data groups are classified into a first class and even-numbered data groups are classified into a second class. However, the above assumption is provided merely for convenience of explanation, and it is understood that according to one or more other exemplary embodiments, data groups may be classified into three or more classes, and classes of the data groups may also be determined according to characteristics other than an encoding/decoding order.

FIG. 10 is a diagram for describing a bitstream reconfiguring process based on a decoding rate, according to an exemplary embodiment.

The entropy encoding apparatus 100 illustrated in FIG. 1 stores bitstreams of each data group in a datastream 1000 including divided spaces of segment 1 1010, segment 2 1030, segment 3 1050, segment 4 1070, and segment 5 1090, and outputs the datastream 1000. The segment 1 1010, the segment 2 1030, the segment 3 1050, the segment 4 1070, and the segment 5 1090 are spaces having the same size, i.e., to which bitstreams of symbols having the same number of bits are allocable.

According to an encoding order of data groups #1 through #4, the data groups #1 and #3 may be classified into class 1, and the data groups #2 and #4 may be classified into class 2. The data group #1 of the class 1 may be allocated to the segment 1 1010, and the data group #2 of the class 2 may be allocated to the segment 2 1030. In the following description, allocating of a data group to a segment or a partial region of the segment may refer to allocating of bitstreams of symbols of the data group.

The next data group #3 of the class 1 may be allocated to a second region 1014 of the segment 1 1010 which remains after the whole data group #1 is allocated to a first region 1012 of the segment 1 1010, and the next data group #4 of the class 2 may be allocated to a second region 1034 of the segment 2 1030 which remains after the whole data group #2 is allocated to a first region 1032 of the segment 2 1030.

It may be understood that the sizes of the first and second regions 1012 and 1014 of the segment 1 1010 to which the data groups #1 and #3 are respectively allocated, and the first and second regions 1032 and 1034 of the segment 2 1030 to which the data groups #2 and #4 are respectively allocated represent the sizes of bitstreams of symbols to be separately allocated and stored.

A decoding rate of each of the data groups #1 through #4 may be expected determined based on a total decoding time or a total number of symbols of each data group. However, since the decoding rate may vary according to the speed of a decoding operation currently performed on a predetermined data group, a decoding time may be short even when the predetermined data group has a large number of symbols, or may be long even when the predetermined data group has a small number of symbols.

On the assumption that symbols have the same decoding rate, it may be assumed that a decoding time of each data group is proportional to the number of symbols of the data group. Hereinafter, for convenience of explanation, a decoding rate of each data group is determined based on a decoding time that is proportional to the number of symbols. However, since a decoding rate and a decoding time of a data group may vary as described above, it is understood that one or more other exemplary embodiments are not limited to the following exemplary embodiments.

If an excess portion is generated because the whole data group #3 is not allocable to the second region 1014 of the segment 1 1010, and if an excess portion is generated because the whole data group #4 is not allocable to the second region 1034 of the segment 2 1030, segments to which the excess portions of the data groups #3 and #4 are allocated are determined.

According to an exemplary embodiment, based on decoding rates of the data groups #3 and #4, segments to which the excess portions of the data groups #3 and #4 are separately allocated may be determined from among the segment 1 1010 and the next segments 3 1050 and 4 1070 adjacent to the segment 1 1010. The segment 2 1030 is excluded because the data group #2 is already allocated to the class 2.

Based on decoding rates of the data groups #3 and #4, a decoding completion time of the data group #3 allocated to the second region 1014 of the segment 1 1010 and a decoding completion time of the data group #4 allocated to the second region 1034 of the segment 2 1030 may be determined. A decoding completion time may be a parsing completion time.

If the decoding completion time of the data group #4 allocated to the second region 1034 of the segment 2 1030 is earlier than that of the data group #3, the excess portion of the data group #4 may be allocated to the next segment 3 1050 that is the most adjacent to the segment 2 1030. Accordingly, together with the segment 2 1030, the segment 3 1050 may also be allocated to the class 2 of the data group #4.

If the decoding completion time of the data group #3 allocated to the second region 1014 of the segment 1 1010 is later than that of the data group #4 allocated to the second region 1034 of the segment 2 1030, from among the neighboring segments 2 1030, 3 1050, and 4 1070 next to the segment 1 1010, the excess portion of the data group #3 may be allocated to the segment 4 1070 other than the segments 2 1030 and 3 1050 already allocated to the class 2. Accordingly, together with the segment 1 1010, the segment 4 1070 may also be allocated to the class 1 of the data group #3.

The data group #3 is completely allocated to the second region 1014 of the segment 1 1010 and a first region 1072 of the segment 4 1070.

If another excess portion is generated after the data group #4 is allocated to the second region 1034 of the segment 2 1030 and a whole region 1052 of the segment 3 1050, from among the segment 4 1070 and the segment 5 1090 next to the segment 3 1050, the other excess portion of the data group #4 may be allocated to the segment 5 1090 other than the segment 4 1070 already allocated to the class 1. Ultimately, the data group #4 may be completely allocated to the second region 1034 of the segment 2 1030, the whole region 1052 of the segment 3 1050, and a first region 1092 of the segment 5 1090.

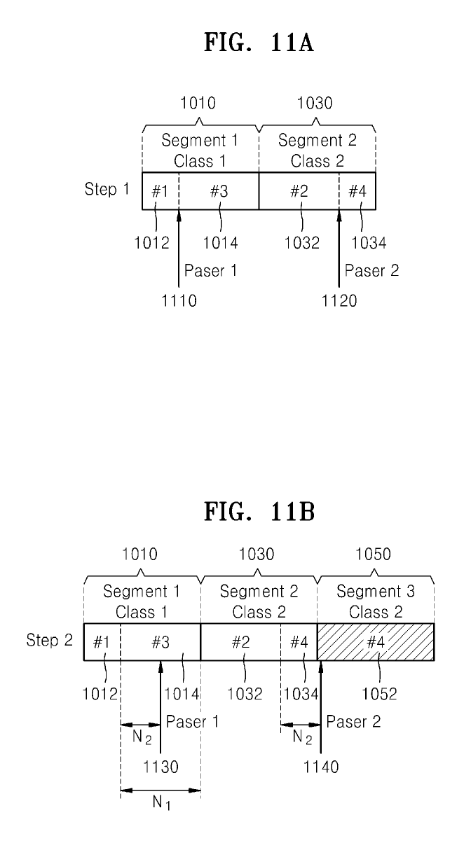

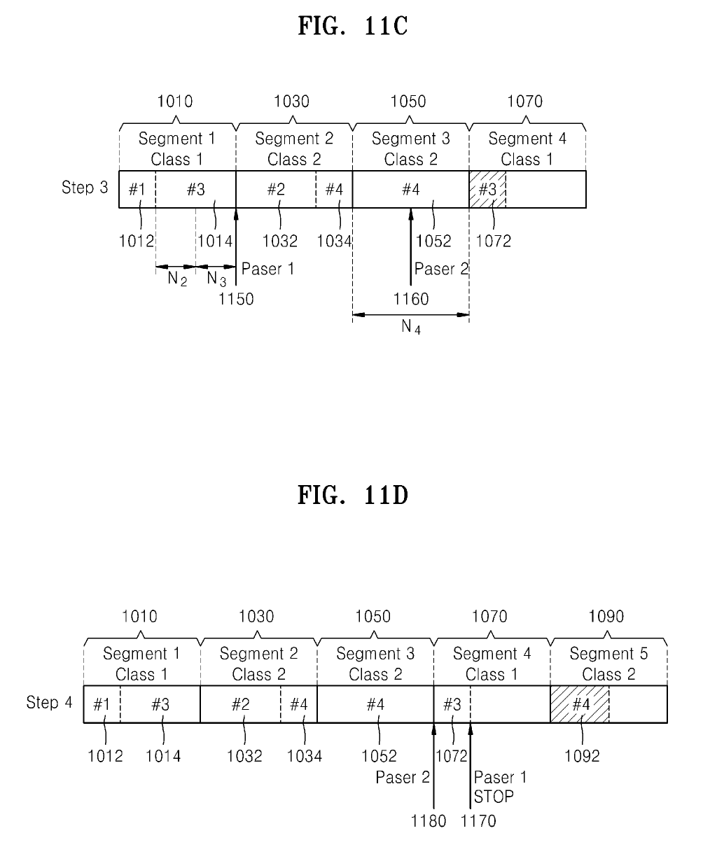

FIGS. 11A through 11D are diagrams for describing a bitstream parsing process based on a decoding rate, according to an exemplary embodiment.

FIGS. 11A through 11D illustrate sequential processes of parsing the datastream 1000 illustrated in FIG. 10. For convenience of explanation, a parsing time is used as a decoding rate.

The entropy decoding apparatus 200 illustrated in FIG. 2 may receive the datastream 1000 and may extract from segments of the datastream 1000 symbols of each data group classified into a class. As described above in relation to FIG. 10, on the assumption that the entropy encoding apparatus 100 illustrated in FIG. 1 classifies the data groups #1 through #4 into classes according to an encoding order and reconfigures streams of the data groups #1 through #4, the entropy decoding apparatus 200 may parse the streams of the data groups #1 through #4 according to a decoding order.

As such, referring to FIG. 11A, according to a decoding order of the data groups #1 through #4, the data group #1 of the class 1 may be parsed from the segment 1 1010 and the data group #2 of the class 2 may be parsed from the segment 2 1030. That is, the segments 1 1010 and 2 1030 may be respectively allocated to the classes 1 and 2.

Since the segments 1 1010 and 2 1030 have the same size, parsers 1 and 2 may respectively access to start parsing the data groups #1 and #2 at the same time.

The parser 1 of the class 1 completes the parsing of the data group #1 at a first point 1110 where the first region 1012 of the segment 1 1010 ends. The parser 2 of the class 2 completes the parsing of the data group #2 at a second point 1120 where the first region 1032 of the segment 2 1030 ends. Each of the parsers 1 and 2 waits until the other completes the parsing.

Referring to FIG. 11B, the parser 1 of the class 1 may start parsing the data group #3 of the class 1 from the second region 1014 of the segment 1 1010 at the first point 1110. Likewise, the parser 2 of the class 2 may start parsing the data group #4 of the class 2 from the second region 1034 of the segment 2 1030 at the second point 1120.

For example, a symbol may be a syntax element. The number of symbols of the data group #3 allocated to the second region 1014 of the segment 1 1010 is N₁, and the number of symbols of the data group #4 allocated to the second region 1034 of the segment 2 1030 is N₂. If the parsers 1 and 2 respectively start parsing at the first and second points 1110 and 1120 at the same time, while the parser 1 parses N₂ number of symbols of the data group #3 from the second region 1014 of the segment 1 1010 so as to reach a third point 1130, the parser 2 may parse N₂ number of symbols of the data group #4 from the second region 1034 of the segment 2 1030 so as to complete the parsing at a fourth point 1114 where the segment 2 1030 ends.

Thus, the parser 1 continues parsing because the data group #3 allocated to the second region 1014 of the segment 1 1010 has more symbols to be parsed. Meanwhile, since the parser 2 completes the parsing of the segment 2 1030, the next segment 3 1050 adjacent to the segment 2 1030 may be allocated to the class 2 that is the same as the class of the segment 2 1030. Accordingly, the parser 2 may parse data groups of the class 2 from the segment 3 1050. The segment 3 1050 may also be allocated to the class 2.

Referring to FIG. 11C, the parsers 1 and 2 continue parsing because the data groups #3 and #4 are not completely parsed. The parser 1 may parse remaining N₃ number of symbols of the data group #3 from the third point 1130 to a fifth point 1150 that is an end point of the second region 1014 of the segment 1 1010. In the meantime, the parser 2 may parse N₃ number of symbols from among N₄ number of symbols of the data group #4 allocated to the whole region 1052 of the segment 3 1050 so as to reach a sixth point 1160.

Thus, the parser 2 continues parsing the segment 3 1050 because the data group #4 allocated to the region 1052 of the segment 3 1050 has more symbols to be parsed. Since the parser 1 completes the parsing of the segment 1 1010 to its end point, from among next segments adjacent to the segment 1 1010, the parser 1 may parse data groups of the class 1 from the segment 4 1070 other than the segment 2 1030 and 3 1050 already allocated to the class 2. Accordingly, the segment 4 1070 may also be allocated to the class 1.

Referring to FIG. 11D, the parser 1 may start parsing remaining symbols of the data group #3 from the segment 4 1070, and may complete the parsing of the data group #3 at a seventh point 1170 that is an end point of the first region 1072 of the segment 4 1070.

The parser 2 parses the data group #4 to an eighth point 1180 that is an end point of the segment 3 1050. Even after the parser 1 completely parses the data group #3, if the data group #4 has more symbols to be parsed, from among the segments 4 1070 and 5 1090 next to the segment 3 1050, the parser 2 may parse the remaining symbols of the data group #4 from the segment 5 1090 other than the segment 4 1070 already allocated to the class 1. Ultimately, the parser 2 may parse the last symbols of the data group #4 from the first region 1092 of the segment 5 1090.

Accordingly, as described above with reference to FIG. 10, since the entropy encoding apparatus 100 transmits a datastream including bitstreams reconfigured by defining classes of data groups and determines a class allocated to each segment based on a decoding rate or a decoding time of bitstreams of each data group, information regarding classes of the bitstreams may not need to be additionally transmitted or received and the entropy decoding apparatus 200 may parse bitstreams from the received datastream, may reclassify the bitstreams according to classes, and may collect symbols according to data groups.

In one or more exemplary embodiments, it is assumed however that the entropy encoding apparatus 100 and the entropy decoding apparatus 200 use the same segment size, the same number of classes, and the same condition for determining a decoding rate or a decoding time.

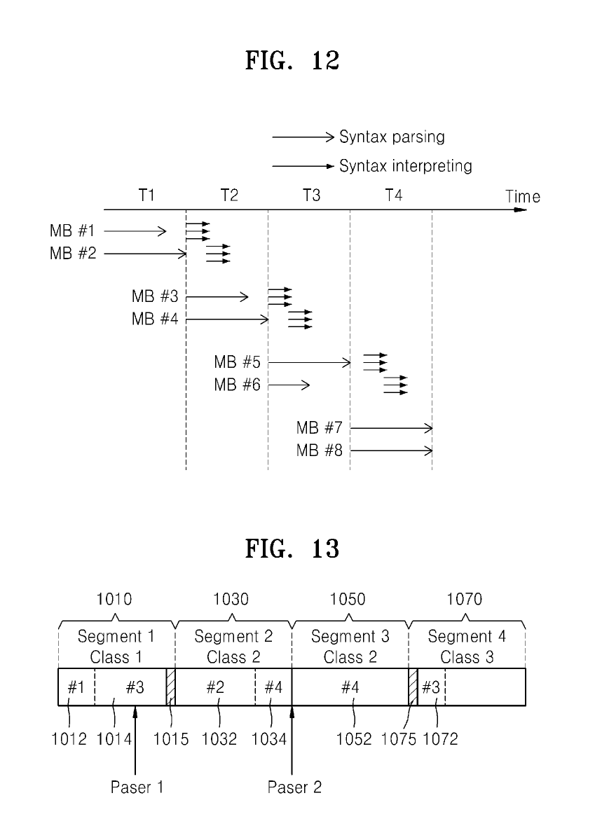

FIG. 12 is a diagram for describing a parallel parsing and reading process according to an exemplary embodiment.

In order to increase video encoding efficiency, only differential information using information of neighboring units may be compressed and transmitted. For example, when a motion vector is encoded, a value of the motion vector itself is not encoded and differential information from a motion vector of a neighboring macroblock is encoded. Also, when block mode information or prediction mode information is encoded, a value to be encoded may vary based on a mode of a neighboring block.

Accordingly, although the entropy encoding apparatus 100 illustrated in FIG. 1 may record macroblocks in parallel according to classes and the entropy decoding apparatus 200 illustrated in FIG. 2 may parse the macroblocks in parallel according to classes, it may not be concluded that symbols of the macroblocks are interpreted in parallel according to classes. For example, in order to decode a current macroblock by using differential information of the current macroblock, a neighboring macroblock of which symbols are already interpreted is referred to. Since neighboring macroblocks are classified into different classes, if a reference macroblock of the current macroblock is a macroblock of another class, symbols of the reference macroblock are to be already interpreted. However, if symbols of neighboring macroblocks of different classes are interpreted in parallel, the symbols of the reference macroblock of the current macroblock may not be interpreted yet and thus the reference macroblock may not be referred to.

Accordingly, the entropy decoding apparatus 200 performs only a parsing operation of macroblocks in parallel according to classes. Referring to FIG. 12, the entropy decoding apparatus 200 may parse syntax of macroblock #1 of class 1 and syntax of macroblock #2 of class 2 in parallel in a cycle T1, may parse syntax of macroblock #3 of the class 1 and syntax of macroblock #4 of the class 2 in parallel in a cycle T2, may parse syntax of macroblock #5 of the class 1 and syntax of macroblock #6 of the class 2 in parallel in a cycle T3, and may parse syntax of macroblock #7 of the class 1 and syntax of macroblock #8 of the class 2 in parallel in a cycle T4.

However, although the syntax of the macroblock #1 of the class 1 and the syntax of the macroblock #2 of the class 2 are parsed in parallel in the cycle T1, the entropy decoding apparatus 200 may interpret the syntax of the macroblock #2 in the cycle T2 based on the syntax of the macroblock #1 after the syntax of the macroblock #1 is completely interpreted. In this manner, the syntax of the macroblock #4 may be interpreted in the cycle T3 after the syntax of the macroblock #3 is completely interpreted, and the syntax of the macroblock #6 may be interpreted in the cycle T4 after the syntax of the macroblock #5 is completely interpreted.

However, syntax elements in the same macroblock may be simultaneously interpreted in parallel. For example, the entropy decoding apparatus 200 may simultaneously interpret an intra prediction mode and a transformation coefficient of the macroblock #1 in the cycle T2.

If the entropy encoding apparatus 100 does not record data groups in parallel according to classes, the entropy decoding apparatus 200 may parse the data groups in parallel by setting a slight delay time between the data groups according to classes. For example, the entropy decoding apparatus 200 may initially start parsing the macroblock #1 of the class 1, and may parse the macroblock #2 of the class 2 after a predetermined delay time even when the macroblock #1 is not completely parsed. Parsing start points may be determined in consideration of the delay time.

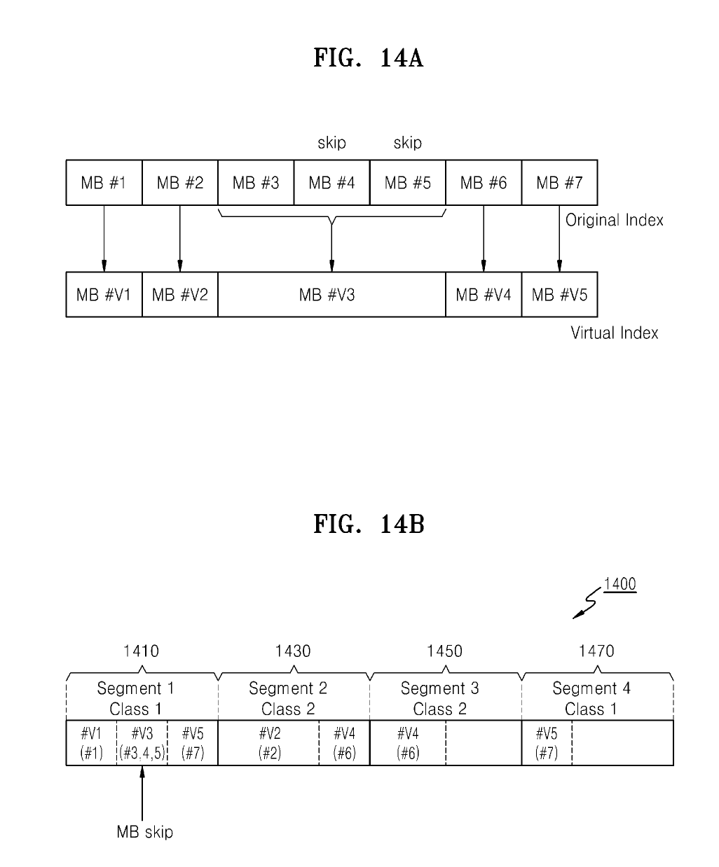

Exceptional cases of reconfiguring and parsing bitstreams and solutions thereof, according to an exemplary embodiment, will now be described with reference to FIGS. 13, 14A, and 14B.

FIG. 13 is a diagram showing an exceptional case of reconfiguring and parsing bitstreams and a solution thereof, according to an exemplary embodiment.

FIG. 13 illustrates a case when symbols of the data group #3 other than its last symbol are allocated to a portion of the second region 1014 of the segment 1 1010 other than its last region 1015. If the size of the last symbol of the data group #3 is greater than that of the last region 1015 of the second region 1014, it may be determined whether to allocate a portion of a bitstream of the last symbol of the data group #3 to the last region 1015 of the second region 1014.

The portion of the bitstream of the last symbol of the data group #3 may be allocated to the last region 1015 of the second region 1014, and a remaining portion of the bitstream not allocated to the last region 1015 may be separately allocated to a partial region 1075 of the segment 4 1070. Otherwise, the last region 1015 of the second region 1014 of the segment 1 1010 may be ignored and the whole bitstream of the last symbol of the data group #3 may be allocated to the first region 1072 of the segment 4 1070.

The entropy encoding apparatus 100 illustrated in FIG. 1 and the entropy decoding apparatus 200 illustrated in FIG. 2 share information regarding the bitstream of the last symbol such that the entropy decoding apparatus 200 may accurately detect segments to which bitstreams are allocated by the entropy encoding apparatus 100, and may accurately reconfigure the bitstreams read from the segments.

FIGS. 14A and 14B are diagrams showing another exceptional case of reconfiguring and parsing bitstreams and a solution thereof, according to an exemplary embodiment.

The entropy encoding apparatus 100 illustrated in FIG. 1 may encode data groups having the same characteristics together or may not encode a portion of the data groups having the same characteristics, according to a video encoding method.

Referring to FIG. 14A, the entropy encoding apparatus 100 may perform entropy encoding on macroblocks MB #1 through MB #7 encoded in units of a macroblock. The entropy encoding apparatus 100 may classify the macroblocks MB #1 through MB #7 into classes.

In this case, if the macroblocks MB #4 and MB #5 are in a skip mode as an inter prediction mode, symbols of the macroblocks MB #4 and MB #5 are not encoded and symbols of the macroblock MB #3 are used in a decoding process. Accordingly, the above described process of classifying data groups into classes and allocating segments according to the classes by the entropy encoding apparatus 100 and the entropy decoding apparatus 200 illustrated in FIG. 2 may not be easily applied to the macroblocks MB #1 through MB #7.

In this case, the entropy encoding apparatus 100 may subordinate the macroblocks MB #4 and MB #5, of which symbols are not encoded, to the macroblock MB#3, and may change original indices of the macroblocks MB #3 through MB #7 into virtual indices. For example, original indices MB #3 through MB #5 of macroblocks including symbols having the same characteristics may be changed into a virtual index MB #V3.

Accordingly, after changing an original index MB #1 into a virtual index MB #V1, an original index MB #2 into a virtual index MB #V2, the original indices MB #3 through MB #5 into the virtual index MB #V3, an original index MB #6 into a virtual index MB #V4, and an original index MB #7 into a virtual index MB #V5, the entropy encoding apparatus 100 may classify macroblocks of the virtual indices MB #V1 through MB #V5 into classes and may determine segments to be allocated.

Also, referring to FIG. 14B, the entropy decoding apparatus 200 may receive a datastream 1400 and may parse macroblocks MB #V1 through MB #V5 allocated according to classes from segments 1410, 1430, 1450, and 1470 of the datastream 1400 based on a decoding rate of each macroblock. However, from among the parsed macroblocks MB #V1 through MB #V5, if it is read or determined that the macroblock MB #V3 is in a skip mode, it may be proved or determined that indices of the macroblocks MB #V1 through MB #V5 are virtual indices. Accordingly, the entropy decoding apparatus 200 may restore macroblocks of original indices MB #3 through MB #5 from the macroblock MB #V3, and may read macroblocks of original indices MB #1 through MB #7.

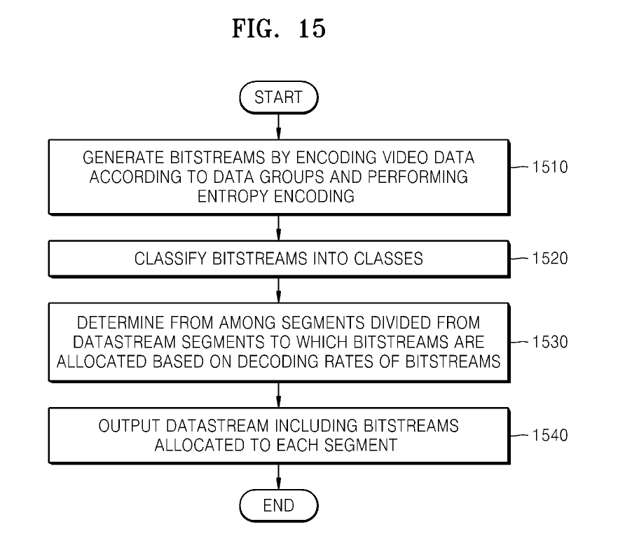

FIG. 15 is a flowchart of an entropy encoding method based on a decoding rate, according to an exemplary embodiment.

Referring to FIG. 15, in operation 1510, bitstreams are generated by dividing video data into a plurality of data groups, encoding each of the data groups to generate symbols, and performing entropy encoding on the symbols.

In operation 1520, the generated bitstreams are classified into a plurality of classes such that bitstreams of neighboring data groups are classified into different classes.

In operation 1530, from among a plurality of segments divided from a datastream, segments to which one or more bitstreams of the same class are allocated are determined based on decoding rates of the bitstreams.

A decoding rate of each data group may be determined based on at least one of a total decoding time and a total number of symbols of the data group. Segments to which each data group is allocated may be determined by comparing decoding rates of data groups of different classes.

If a bitstream of a first class is allocated to a first segment and a bitstream of a second class is allocated to a second segment, decoding rates of the bitstreams of the first and second classes may be compared to determine next segments to which the bitstreams of the first and second classes are allocated. Based on the comparison result, an excess portion of the bitstream of the first class which is not allocated to the first segment may be continuously allocated to a segment that is the most adjacent to the first segment from among segments other than segments already allocated to a class other than the first class.

In operation 1540, a datastream including bitstreams allocated to each segment is output.

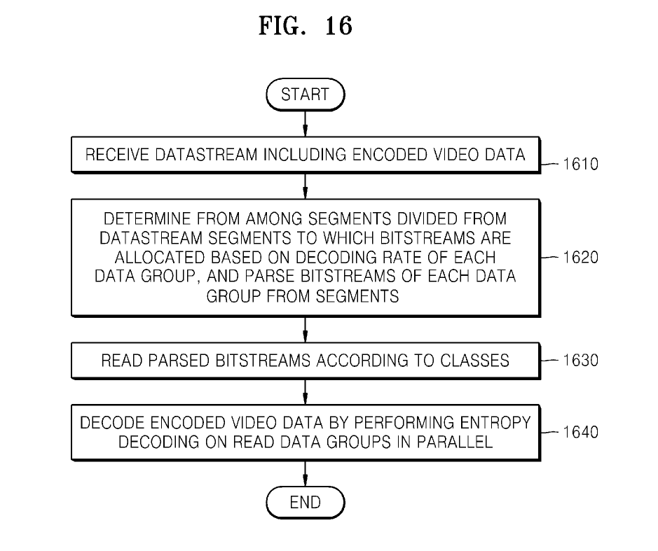

FIG. 16 is a flowchart of an entropy decoding method based on a decoding rate, according to an exemplary embodiment.

Referring to FIG. 16, in operation 1610, a datastream including symbols generated by dividing video data into a plurality of data groups and encoding each of the data groups is received.

In operation 1620, from among a plurality of segments divided from the datastream, segments to which bitstreams of one or more data groups of the same class are allocated are determined. In particular, segments to which bitstreams of data groups of one class are allocated may be determined based on a decoding rate of each data group. Bitstreams of each data group may be parsed from the segments according to classes.

The decoding rate of each data group may be determined based on at least one of a total decoding time and a total number of symbols of the data group, and segments from which data groups of a predetermined class are parsed may be determined based on the decoding rate of the data groups.

Segments from which data groups of different classes are parsed may be determined by comparing decoding rates of the data groups. If a bitstream of a first class is parsed from a first segment and a bitstream of a second class is parsed from a second segment, decoding rates of the bitstreams of the first and second classes are compared. Based on the comparison result, an excess portion of the bitstream of the first class which is not parsed from the first segment, may be continuously parsed from a segment that is the most adjacent to the first segment from among segments other than segments already allocated to the second class.

In operation 1630, bitstreams parsed according to a plurality of classes are read from segments. From among the read bitstreams, bitstreams of neighboring data groups are classified into different classes.

In operation 1630, entropy decoding is performed on read data groups in parallel so as to extract symbols such as encoded video data, and video data is restored by decoding the symbols. Entropy decoding may be performed in parallel on bitstreams of the read data groups according to classes.

The block diagrams disclosed above may be construed by one of ordinary skill in the art as conceptually expressing circuits for implementing principles of exemplary embodiments. Similarly, it is obvious to one of ordinary skill in the art that a flowchart, a status transition view, a pseudo-code, or the like, may be substantially expressed in a computer-readable medium to denote various processes which can be executed by a computer or a processor whether or not the computer or the processor is clarified or not. Thus, the foregoing exemplary embodiments may be embodied as programs which can be executed by computers and may be implemented in a general digital computer operating the programs by using a computer-readable recording medium. The computer-readable medium may include storage mediums such as a magnetic storage medium (e.g., a ROM, a floppy disk, a hard disk, or the like), an optical reading medium (e.g., a CD-ROM, a DVD, or the like).

Functions of various elements illustrated in the drawings may be provided by the use of dedicated hardware as well as by hardware which is related to appropriate software and can execute the software. When provided by a processor, such functions may be provided by a single dedicated processor, a single shared processor, or a plurality of individual processors which can share some of the functions. Also, the stated use of terms “processor” or “controller” should not be construed to exclusively designate hardware which can execute software and may tacitly include digital signal processor (DSP) hardware, a ROM for storing software, a RAM, and a non-volatile storage device, without any limitation.

In the claims, elements expressed as units for performing particular functions may cover a certain method performing a particular function, and such elements may include a combination of circuit elements performing particular functions, or software in a certain form including firmware, microcodes, or the like, combined with appropriate circuits to perform software for performing particular functions.

Designation of ‘an embodiment’ of the principles and various modifications of such an expression may mean that particular features, structures, characteristics, and the like, in relation to this embodiment are included in at least one embodiment of the principle of the present invention. Thus, the expression ‘an embodiment’ and any other modifications disclosed throughout the entirety of the disclosure may not necessarily designate the same embodiment.

In the specification, in a case of ‘at least one of A and B’, the expression of ‘at least one of ˜’ is used to cover only a selection of a first option (A), only a selection of a second option (B), or a selection of both options (A and B). In another example, in a case of ‘at least one of A, B, and C’, the expression of ‘at least one of ˜’ is used to cover only a selection of a first option (A), only a selection of a second option (B), only a selection of a third option (C), only a selection of the first and second options (A and B), only a selection of the second and third options (B and C), only a selection of the first and third options (A and C), or a selection of all of the three options (A, B, and C). Even when more items are enumerated, it will be obvious to one of ordinary skill in the art that the items can be definitely extendedly construed.

While exemplary embodiments have been particularly shown and described above, it will be understood by one of ordinary skill in the art that various changes in form and details may be made therein without departing from the spirit and scope of the present inventive concept as defined by the following claims. The exemplary embodiments should be considered in a descriptive sense only and not for purposes of limitation. Therefore, the scope of the invention is defined not by the detailed description of exemplary embodiments, but by the following claims, and all differences within the scope will be construed as being included in the present invention.

What is claimed is:

1. An entropy encoding method comprising:
generating bitstreams by dividing video data into a plurality of data groups, encoding the plurality of data groups so as to generate symbols, and performing entropy encoding on the generated symbols;
classifying the generated bitstreams into a plurality of classes such that bitstreams of neighboring data groups, among the plurality of data groups, are classified into different classes;
determining, from among a plurality of segments divided from a datastream, segments to which one or more bitstreams of a same class are allocated based on decoding rates of the generated bitstreams; and
outputting a datastream comprising bitstreams allocated to each segment according to the determining.

2. The entropy encoding method of claim 1, wherein the determining of the segments comprises:
determining a decoding rate of a data group, among the plurality of data groups, based on at least one of a total decoding time and a total number of symbols of the data group; and
determining segments to which bitstreams of the data group are allocated based on the determined decoding rate of the data group, and
wherein a respective one of the plurality of classes corresponds to each segment of the plurality of segments.

3. The entropy encoding method of claim 1, wherein:
the classifying of the generated bitstreams comprises respectively classifying a first bitstream and a second bitstream that are continuous according to an encoding order of the plurality of data groups, into a first class and a second class that are continuous; and
the determining of the segments comprises storing the first bitstream of the first class in a first segment, among the plurality of segments, and storing the second bitstream of the second class in a second segment, among the plurality of segments.

4. The entropy encoding method of claim 1, wherein the determining of the segments comprises:
determining a segment, among the plurality of segments, to which a first bitstream is allocated; and
allocating a next bitstream of the first bitstream, which is classified into a same class as the first bitstream, to a remaining region of the determined segment other than a region allocated to the first bitstream.

5. The entropy encoding method of claim 1, wherein the determining of the segments comprises:
determining a first segment, among the plurality of segments, to which a first bitstream of a first class is allocated;
determining a second segment, among the plurality of segments, to which a second bitstream of a second class is allocated;
comparing a decoding rate of the first bitstream with a decoding rate of the second bitstream; and
based on a result of the comparing, continuously allocating an excess portion of the first bitstream of the first class, which is not allocated to the first segment, to a segment that is most adjacent to the first segment from among segments other than segments already allocated to the second class.

6. The entropy encoding method of claim 1, wherein:
each of the plurality of segments is allocated to a respective one of the plurality of classes; and
a total number of the plurality of classes is a number of data groups entropy-decodable in parallel in one cycle.

7. The entropy encoding method of claim 1, wherein the determining of the segments comprises:
determining a first segment, among the plurality of segments, to which a first bitstream of a first class is allocated; and
if a size of a bitstream of a last symbol of the first bitstream is greater than a size of a remaining region of the first segment, determining whether to separately allocate the bitstream of the last symbol to the remaining region of the first segment and a second segment corresponding to the first class.

8. The entropy encoding method of claim 1, wherein, if a plurality of data groups that are continuous according to an encoding order of data groups have same encoding characteristics, the classifying of the generated bitstreams comprises:
indexing the plurality of data groups having the same encoding characteristics as one predetermined virtual data group; and
indexing a next data group of the plurality of data groups having the same encoding characteristics as a next virtual data group of the predetermined virtual data group.

9. The entropy encoding method of claim 1, wherein the classifying of the generated bitstreams comprises:
determining bitstreams of a current data group based on context regarding symbols of neighboring data groups from among data groups classified into a same class; and
determining context regarding the current data group based on the determined bitstreams of the current data group.

10. An entropy decoding method comprising:
receiving a datastream comprising video data divided into a plurality of data groups and then encoded;
determining, from among a plurality of segments divided from the datastream, segments to which one or more bitstreams of a same class are allocated based on decoding rates of the plurality of data groups, and parsing bitstreams of the plurality of data groups from the segments;
reading the parsed bitstreams according to a plurality of classes classified such that bitstreams of neighboring data groups, among the plurality of data groups, are classified into different classes; and
decoding the encoded video data by performing entropy decoding on read data groups in parallel.

11. The entropy decoding method of claim 10, wherein the decoding rate of a data group, among the plurality of data groups, is determined based on at least one of a total decoding time and a total number of symbols of the data group.

12. The entropy decoding method of claim 10, wherein:
the parsing comprises allocating each segment to a respective one of the plurality of classes and parsing bitstreams in parallel from segments allocated according to the plurality of classes; and
the decoding comprises performing entropy decoding in parallel on bitstreams of the read data groups according to the plurality of classes.

13. The entropy decoding method of claim 10, wherein the parsing comprises:
respectively parsing a first bitstream of a first class and a second bitstream of a second class, which are continuous according to a decoding order of the plurality of data groups, from a first segment and a second segment, among the plurality of segments; and
allocating the first segment to the first class and allocating the second segment to the second class.

14. The entropy decoding method of claim 10, wherein the parsing comprises:
parsing a first bitstream of a first class from a first segment of the plurality of segments; and
parsing a second bitstream that is a next bitstream of the first bitstream and is classified into the first class, from a remaining region of the first segment other than a region allocated to the first bitstream.

15. The entropy decoding method of claim 10, wherein the parsing comprises:
parsing a first bitstream of a first class from a first segment of the plurality of segments;
parsing a second bitstream of a second class from a second segment of the plurality of segments;
comparing a decoding rate of the first bitstream with a decoding rate of the second bitstream; and
based on a result of the comparing, continuously parsing an excess portion of the first bitstream of the first class, which is not parsed from the first segment, from a segment that is most adjacent to the first segment from among segments other than segments already allocated to the second class.

16. The entropy decoding method of claim 10, wherein the parsing comprises:
parsing a first bitstream of a first class from a first segment of the plurality of segments; and
if a size of a bitstream of a last symbol of the first bitstream is greater than a size of a remaining region of the first segment, determining whether to separately parse the bitstream of the last symbol from the remaining region of the first segment and a second segment corresponding to the first class.

17. The entropy decoding method of claim 10, wherein the parsing comprises:
parsing a plurality of data groups indexed as a predetermined virtual data group, having same encoding characteristics, and continuously encoded; and
parsing a next data group of the plurality of data groups having the same encoding characteristics, which is indexed as a next virtual data group of the predetermined virtual data group.

18. The entropy decoding method of claim 10, wherein the decoding comprises:
determining bitstreams of a current data group based on context regarding symbols of neighboring data groups from among data groups read according to the plurality of classes and classified into a same class; and
determining context regarding the current data group based on the determined bitstreams of the current data group.

19. A video encoding apparatus comprising:
an encoding unit which divides video data into a plurality of data groups and encodes the plurality of data groups so as to generate symbols;
an entropy encoding performing unit which generates bitstreams by performing entropy encoding on the generated symbols;
a bitstream storage which reconfigures the generated bitstreams by classifying the generated bitstreams into a plurality of classes such that bitstreams of neighboring data groups, among the plurality of data groups, are classified into different classes, and determines, from among a plurality of segments divided from a datastream, segments to which one or more bitstreams of a same class are allocated based on decoding rates of the generated bitstreams; and
an output unit which outputs a datastream comprising bitstreams allocated to each segment according to the determining of the segments.

20. The video encoding apparatus of claim 19, wherein the encoding unit further comprises:
a motion estimation unit which estimates motion between frames of input video data;
an inter prediction unit which performs inter prediction by using motion information between the frames;
an intra prediction unit which performs intra prediction by using information of neighboring pixels of one frame from among the frames; and
a transformation and quantization unit which performs frequency transformation and quantization on residual video data generated by performing prediction encoding,
wherein the generated symbols comprise various types of encoding information to control an encoding process, quantized coefficients of the residual video data of the plurality of data groups, and the motion information.

21. A video decoding apparatus comprising:
a reception unit which receives a datastream comprising video data divided into a plurality of data groups and then encoded;
a bitstream read unit which determines, from among a plurality of segments divided from the datastream, segments to which one or more bitstreams of a same class are allocated based on decoding rates of the plurality of data groups, parses bitstreams of the plurality of data groups from the segments, and reads the parsed bitstreams according to a plurality of classes classified such that bitstreams of neighboring data groups, among the plurality of data groups, are classified into different classes;
an entropy decoding performing unit which performs entropy decoding on read data groups in parallel and outputs the encoded video data; and
a decoding unit which decodes the encoded video data.

22. The video decoding apparatus of claim 21, wherein:
the entropy decoding performing unit generates symbols of the plurality of data groups, which comprise quantized coefficients of residual video data of the plurality of data groups, encoding information, and motion information, by performing entropy decoding; and
the decoding unit further comprises:
an inverse quantization and inverse transformation unit which restores video data of the plurality of data groups by performing inverse quantization and inverse frequency transformation on the quantized coefficients of the residual video data of the data groups;
a motion compensation unit which performs inter prediction by using the motion information and the residual video data of the plurality of data groups;
an intra prediction unit which performs intra prediction on the video data of the plurality of data groups; and
a deblocking performing unit which restores original video data by performing deblocking filtering on the video data of the plurality of data groups and the video data on which the intra prediction and motion compensation are performed.

23. A computer readable recording medium having recorded thereon a computer program for executing the entropy encoding method of claim 1.

24. A computer readable recording medium having recorded thereon a computer program for executing the entropy decoding method of claim 10.

25. An entropy encoding method comprising:
classifying bitstreams of data groups, which are generated by performing entropy encoding on a plurality of symbols of the data groups, into a plurality of classes such that bitstreams of neighboring data groups, among the plurality of data groups, are classified into different classes;
determining, from among a plurality of segments divided from a datastream, segments to which one or more bitstreams of a same class are allocated based on decoding rates of the generated bitstreams; and
outputting a datastream comprising bitstreams allocated to each segment according to the determining.

26. A computer readable recording medium having recorded thereon a computer program for executing the entropy decoding method of claim 25.

27. An entropy decoding method comprising:
determining bitstreams of a plurality of data groups from segments, of a datastream, to which one or more bitstreams of a same class are allocated based on decoding rates of the plurality of data groups;
reading the determined bitstreams according to a plurality of classes classified such that bitstreams of neighboring data groups, among the plurality of data groups, are classified into different classes; and
decoding the encoded video data by performing entropy decoding on read data groups in parallel.

28. A computer readable recording medium having recorded thereon a computer program for executing the entropy decoding method of claim 27.
